(19) United States
(12) Patent Application Publication
(10) Pub. No.: US 2018/0267764 A1
(43) Pub. Date: Sep. 20, 2018

(54) MODULARIZED LIQUID CRYSTAL DISPLAY DEVICE

(71) Applicants: Yong FAN, Shenzhen (CN); Shengjer CHANG CHIEN, Shenzhen (CN)

(72) Inventors: Yong FAN, Shenzhen (CN); Shengjer CHANG CHIEN, Shenzhen (CN)

(73) Assignee: SHENZHEN CHINA STAR OPTOELECTRONICS TECHNOLOGY CO., LTD., Shenzhen (CN)

(21) Appl. No.: 15/327,400

(22) PCT Filed: Dec. 28, 2016
(86) PCT No.: PCT/CN2016/112536

§ 371 Date: Jan. 19, 2017

(30) Foreign Application Priority Data
Dec. 5, 2016 (CN) 201611106263.6

(51) Int. Cl. G06F 3/14; G02F 1/1339; G02F 1/1335; G02F 1/1333

(52) U.S. Cl. CPC G06F 3/1446; G02F 1/1339; G02F 1/133603; G02F 1/133382; G02F 1/133553

(57) ABSTRACT

A modularized liquid crystal display device is provided. The modularized liquid crystal display device has a first liquid crystal display panel, a second liquid crystal display panel, a light source module, and two sided sealing structural components. Lower portions of the first liquid crystal display panel and the second liquid crystal display panel are connected to each other. A sealed containing space is constructed by the first liquid crystal display panel, the second liquid crystal display panel, the light source module, and the two sided sealing structural components. The light source module has LED light sources, at least one reflection sheet, and a heat sink.

### FIELD OF THE INVENTION

The present invention relates to the field of display design, and more particularly to a modularized liquid crystal display device.

### BACKGROUND OF THE INVENTION

FIG. 1 is a schematic structural view of a conventional modularized liquid crystal display device. A modularized liquid crystal display device 10 is a double-sided liquid crystal display device, which is widely used in the commercial display field, such as high speed rails or markets. The modularized liquid crystal display device 10 includes two liquid crystal display modules, each of which includes a reflection sheet 11, a light guide plate 12, an optical film set 13, a liquid crystal display panel 14, and a light source 15, wherein the two liquid crystal display panels are connected by a connecting component 16.

As shown in FIG. 1, the modularized liquid crystal display device 10 has a larger integral volume, and the energy consumption and the heat dissipation effect are also worse.

Hence, it is necessary to provide a modularized liquid crystal display device so as to solve the problems existing in the conventional technologies.

### SUMMARY OF THE INVENTION

The present invention provides a modularized liquid crystal display device which has a good displaying effect, lower energy consumption, and a better heat dissipation effect. It can solve the technical problems of the prior art: a conventional modularized liquid crystal display device has a larger integral volume, and the energy consumption and the heat dissipation effect are worse.

One preferred embodiment of the present invention provides a modularized liquid crystal display device, which comprises:

a first liquid crystal display panel;
a second liquid crystal display panel;
a light source module disposed on upper portions of the first liquid crystal display panel and the second liquid crystal display panel; and
two sided sealing structural components disposed on side portions of the first liquid crystal display panel and the second liquid crystal display panel;
wherein lower portions of the first liquid crystal display panel and the second liquid crystal display panel are connected to each other; and a sealed containing space is constructed by the first liquid crystal display panel, the second liquid crystal display panel, the light source module, and the two sided sealing structural components;
wherein the light source module includes: LED light sources disposed inside the containing space; at least one reflection sheet configured to reflect lights emitted from the LED light sources; and a heat sink disposed outside the containing space;
wherein an included angle between a plane of the first liquid crystal display panel and a plane of the second liquid crystal display panel is less than or equal to 120 degrees; and
wherein a surface of the first liquid crystal display panel facing the containing space is provided with a first optical film set; and a surface of the second liquid crystal display panel facing the containing space is provided with a second optical film set.

In the modularized liquid crystal display device of the present invention, the LED light sources are disposed inside the containing space by a light source layout plate; and the reflection sheet is disposed among the adjacent LED light sources.

In the modularized liquid crystal display device of the present invention, on the light source layout plate, an area with a smaller arranging-distance-value has a greater distribution density of the LED light sources than that of an area with a greater arranging-distance-value, wherein the arranging-distance-value is an absolute value of an difference value between a distance from the area to the first liquid crystal display panel, and a distance from the area to the second liquid crystal display panel.

In the modularized liquid crystal display device of the present invention, the LED light sources are disposed inside the sealed containing space by a projection component, and two of the reflection sheets are disposed on two sides of the projection component.

In the modularized liquid crystal display device of the present invention, the LED light sources are evenly disposed on outer surfaces of the projection component.

In the modularized liquid crystal display device of the present invention, the LED light sources are disposed inside the sealed containing space by a heat sink projection component, and two of the reflection sheets are disposed on two sides of the projection component.

In the modularized liquid crystal display device of the present invention, the heat sink projection component is connected with the heat sink.

In the modularized liquid crystal display device of the present invention, a surface of the sided sealing structural components facing the containing space is provided with the reflection sheet.

One preferred embodiment of the present invention further provides a modularized liquid crystal display device, which comprises:

a first liquid crystal display panel;
a second liquid crystal display panel;
a light source module disposed on upper portions of the first liquid crystal display panel and the second liquid crystal display panel; and
two sided sealing structural components disposed on side portions of the first liquid crystal display panel and the second liquid crystal display panel;
wherein lower portions of the first liquid crystal display panel and the second liquid crystal display panel are connected to each other; and a sealed containing space is constructed by the first liquid crystal display panel, the second liquid crystal display panel, the light source module, and the two sided sealing structural components;
wherein the light source module includes: LED light sources disposed inside the containing space; at least one reflection sheet configured to reflect lights emitted from the LED light sources; and a heat sink disposed outside the containing space.

In the modularized liquid crystal display device of the present invention, the LED light sources are disposed inside the containing space by a light source layout plate; and the reflection sheet is disposed among the adjacent LED light sources.

In the modularized liquid crystal display device of the present invention, on the light source layout plate, an area with a smaller arranging-distance-value has a greater distribution density of the LED light sources than that of an area with a greater arranging-distance-value, wherein the arranging-distance-value is an absolute value of an difference value between a distance from the area to the first liquid crystal display panel, and a distance from the area to the second liquid crystal display panel.

In the modularized liquid crystal display device of the present invention, the LED light sources are disposed inside the sealed containing space by a projection component, and two of the reflection sheets are disposed on two sides of the projection component.

In the modularized liquid crystal display device of the present invention, the LED light sources are evenly disposed on outer surfaces of the projection component.

In the modularized liquid crystal display device of the present invention, the LED light sources are disposed inside the sealed containing space by a heat sink projection component, and two of the reflection sheets are disposed on two sides of the projection component.

In the modularized liquid crystal display device of the present invention, the heat sink projection component is connected with the heat sink.

In the modularized liquid crystal display device of the present invention, an included angle between a plane of the first liquid crystal display panel and a plane of the second liquid crystal display panel is less than or equal to 120 degrees.

In the modularized liquid crystal display device of the present invention, a surface of the first liquid crystal display panel facing the containing space is provided with a first optical film set; and a surface of the second liquid crystal display panel facing the containing space is provided with a second optical film set.

In the modularized liquid crystal display device of the present invention, a surface of the sided sealing structural components facing the containing space is provided with the reflection sheet.

Compared with a conventional modularized liquid crystal display device, in the modularized liquid crystal display device according to the preferred embodiment of the present invention, by the design of the structure of the containing space, the structure of the modularized liquid crystal display device is simplified, and the heat dissipation effect of the modularized liquid crystal display device is increased. Furthermore, since the luminous efficiency is increased, the energy consumption of the modularized liquid crystal display device is lowered. Therefore, it can solve the technical problems of the prior art: the conventional modularized liquid crystal display device has a larger integral volume, and the energy consumption and the heat dissipation effect are worse.

The above-mentioned contents of the present invention can be best understood by referring to the following detailed description of the preferred embodiments and the accompanying drawings.

### DESCRIPTION OF THE DRAWINGS

FIG. 1 is a schematic structural view of a conventional modularized liquid crystal display device.

FIG. 2 is a schematic structural view of a modularized liquid crystal display device according to a first preferred embodiment of the present invention.

FIG. 3 is a cross-sectional view along a cross-sectional line A-A′ of FIG. 2.

FIG. 4 is a schematic view showing an arrangement of LED light sources on a light source layout plate according to the first preferred embodiment of the present invention.

FIG. 5 is a schematic structural view of a modularized liquid crystal display device according to a second preferred embodiment of the present invention.

FIG. 6 is a schematic structural view of a modularized liquid crystal display device according to a third preferred embodiment of the present invention.

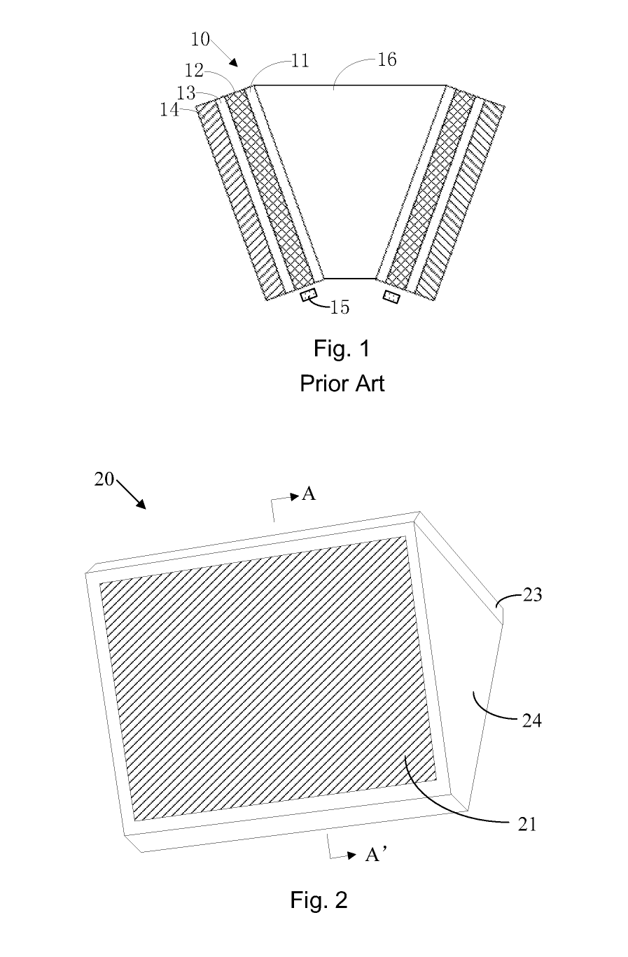

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inside, outer, side, etc., are only directions with reference to the accompanying drawings, so that the used directional terms are used to describe and understand the present invention, but the present invention is not limited thereto.

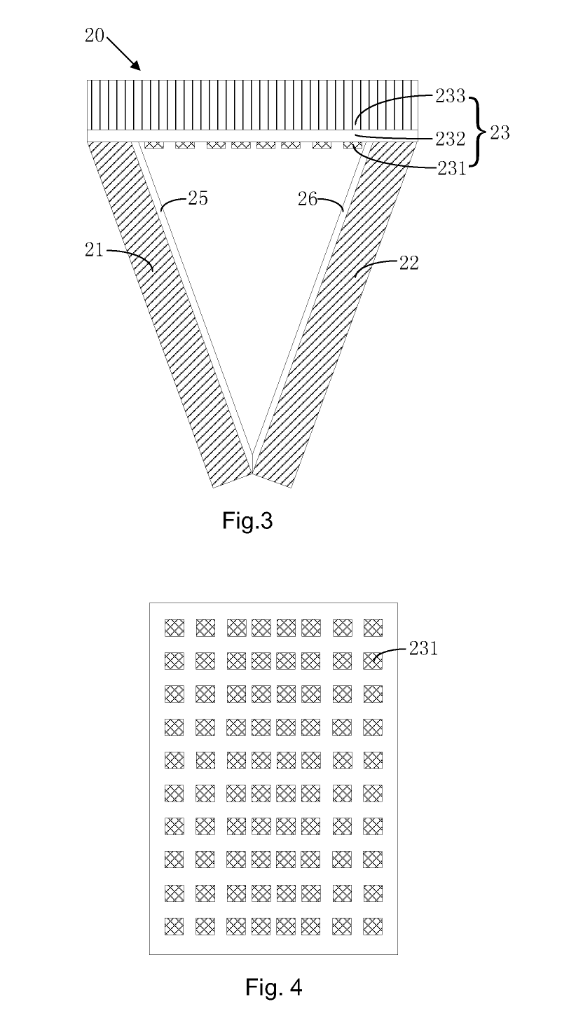

Refer now to FIGS. 2 to 4, wherein FIG. 2 is a schematic structural view of a modularized liquid crystal display device according to a first preferred embodiment of the present invention; FIG. 3 is a cross-sectional view along a cross-sectional line A-A′ of FIG. 2; and FIG. 4 is a schematic view showing an arrangement of LED light sources on a light source layout plate according to the first preferred embodiment of the present invention.

A modularized liquid crystal display device 20 of the preferred embodiment includes a first liquid crystal display panel 21, a second liquid crystal display panel 22, a light source module 23, and two sided sealing structural components 24. The light source module 23 is disposed on upper portions of the first liquid crystal display panel 21 and the second liquid crystal display panel 22. The sided sealing structural components 24 are disposed on side portions of the first liquid crystal display panel 21 and the second liquid crystal display panel 22. Lower portions of the first liquid crystal display panel 21 and the second liquid crystal display panel 22 are connected to each other. A sealed containing space is constructed by the first liquid crystal display panel 21, the second liquid crystal display panel 22, the light source module 23, and the two sided sealing structural components 24. An included angle between a plane of the first liquid crystal display panel 21 and a plane of the second liquid crystal display panel 22 is less than or equal to 120 degrees.

Preferably, a surface of the first liquid crystal display panel 21 facing the containing space is provided with a first optical film set 25; and a surface of the second liquid crystal display panel 22 facing the containing space is provided with a second optical film set 26.

As shown in FIG. 3, the light source module 23 includes LED light sources 231, a reflection sheet 232, and a heat sink 233. The LED light sources 231 are disposed inside the containing space by a light source layout plate. The reflection sheet 232 is disposed among the adjacent LED light sources 231, and is configured to reflect lights emitted from the LED light sources 231. The heat sink 233 is disposed outside the containing space. At the same time, there is also a reflection sheet disposed on a surface of the sided sealing structural components 24 facing the containing space (not shown), so that the lights emitted from the LED light sources 231 only can be output through the first liquid crystal display panel 21 and the second liquid crystal display panel 22, and the heat produced from the light sources 231 can be beneficially exported through the heat sink 233.

As shown in FIG. 4, on the light source layout plate, an area with a smaller arranging-distance-value has a greater distribution density of the LED light sources 231 than that of an area with a greater arranging-distance-value, wherein the arranging-distance-value is the absolute value of the difference value between a distance from the area to the first liquid crystal display panel 21, and a distance from the area to the second liquid crystal display panel 22.

Because each area of the first liquid crystal display panel 21 and the second liquid crystal display panel 22 has a different distance to the light source layout plate, according to the specific distances between the light source layout plate and the liquid crystal display panels, the distribution density of the LED light sources 231 is set. That is, if the area has a larger distance between the light source layout plate and the corresponding liquid crystal display panel, the LED light sources 231 has a greater distribution density, so as to ensure that displaying brightness of the first liquid crystal display panel 21 and the second liquid crystal display panel 22 can be even and identical.

When the modularized liquid crystal display device 20 of the preferred embodiment is in use, the most of the lights from the LED light sources 231 of the light source module 23 are directly emitted onto the first liquid crystal display panel 21 and the second liquid crystal display panel 22 through the containing space. Additionally, by disposing the reflection sheets 232 of containing space, the rest of the lights which are not directly emitted onto the first liquid crystal display panel 21 and the second liquid crystal display panel 22 are reflected back to the containing space, and then finally emitted out of the first liquid crystal display panel 21 and the second liquid crystal display panel 22. Therefore, the energy consumption of the modularized liquid crystal display device 20 is efficiently lowered. At the same time, the heat sink 233 of the light source module 23 can efficiently process a heat dissipation for the LED light sources 231, so that based on the luminous efficiency being ensured, by disposing the containing space, the heat dissipation effect of the modularized liquid crystal display device 20 is increased, so as to lower the energy consumption of the modularized liquid crystal display device 20.

For visual effect, because the included angle formed between the plane of the first liquid crystal display panel 21 and the plane of the second liquid crystal display panel 22 is less than 120 degrees, the first liquid crystal display panel 21 and the second liquid crystal display panel 22 are both tilt-down displays, so that a better visual range is provided for users who walk under the modularized liquid crystal display device 20.

Therefore, in the modularized liquid crystal display device of the preferred embodiment, by the design of the structure of the containing space, the structure of the modularized liquid crystal display device is simplified, and the heat dissipation effect of the modularized liquid crystal display device is increased. Furthermore, since the luminous efficiency is increased, the energy consumption of the modularized liquid crystal display device is lowered.

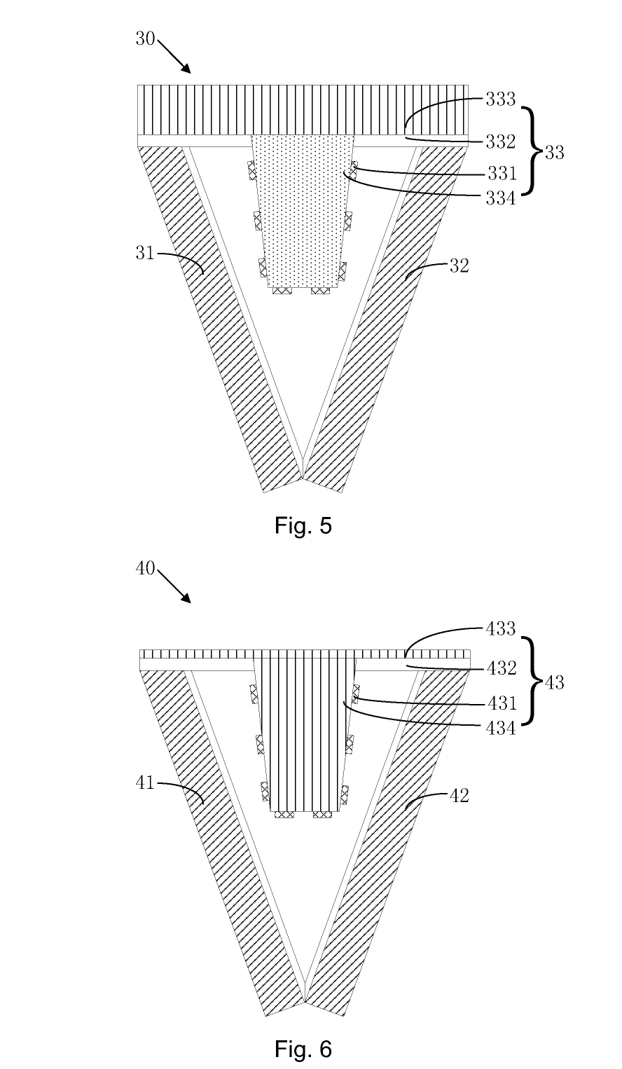

Refer now to FIG. 5, which is a schematic structural view of a modularized liquid crystal display device according to a second preferred embodiment of the present invention. A modularized liquid crystal display device 30 of the preferred embodiment includes a first liquid crystal display panel 31, a second liquid crystal display panel 32, a light source module 33, and two sided sealing structural components 34.

The light source module 33 includes LED light sources 331, reflection sheets 332, a heat sink 333, and a projection component 334.

Based on the first preferred embodiment, by disposing one of the projection component 334, the LED light sources 331 of the light source module 33 of the modularized liquid crystal display device 30 of the preferred embodiment are disposed inside the sealed containing space, and the reflection sheets 332 are disposed on two sides of the projection component 334. Because the projection component 334 is disposed in the center of the sealed containing space, the distance between the LED light sources 331 and the corresponding liquid crystal panels is improved. Additionally, because the reflected, indirectly emitted lights are reduced, the luminous efficiency of the LED light sources 331 is further increased.

If the projection component 334 is disposed with a proper height, the LED light sources 331 can be evenly disposed on the outer surfaces of the projection component 334, so as to simplify the installation manner of the LED light sources 331.

The operating principle of the modularized liquid crystal display device 30 of the preferred embodiment is the same as or similar to the above-mentioned description in the modularized liquid crystal display device 20 of the first preferred embodiment, so for the specific details refer to the related description in the modularized liquid crystal display device 20 of the first preferred embodiment.

Based on the first preferred embodiment, by disposing the projection component, the modularized liquid crystal display device of the preferred embodiment can further increase the luminous efficiency, and simplify the installation manner of the LED light sources.

Refer now to FIG. 6, which is a schematic structural view of a modularized liquid crystal display device according to a third preferred embodiment of the present invention. A modularized liquid crystal display device 40 of the preferred embodiment includes a first liquid crystal display panel 41, a second liquid crystal display panel 42, a light source module 43, and two sided sealing structural components 44.

The light source module 43 includes LED light sources 431, reflection sheets 432, a heat sink 433, and a heat sink projection component 434.

Based on the first preferred embodiment, by disposing one of the heat sink projection component 434, the LED light sources 431 of the light source module 43 of the modularized liquid crystal display device 40 of the preferred embodiment are disposed inside the sealed containing space, and the reflection sheets 432 are disposed on two sides of the heat sink projection component 434, wherein the heat sink projection component 434 is connected with the heat sink 433. Because the heat sink projection component 434 is disposed in the center of the sealed containing space, the distance between the LED light sources 431 and the corresponding liquid crystal panels is improved. Additionally, because the reflected, indirectly emitted lights are reduced, the luminous efficiency of the LED light sources 431 is further increased.

If the heat sink projection component 434 is disposed with a proper height, the LED light sources 431 can be evenly disposed on the surfaces of the heat sink projection component 434, so as to simplify the installation manner of the LED light sources 431.

At the same time, by disposing the heat sink projection component 434, the volume of the heat sink 433 can be correspondingly reduced, so as to reduce the whole of the volume of the modularized liquid crystal display device 40.

The operating principle of the modularized liquid crystal display device 40 of the preferred embodiment is the same as or similar to the above-mentioned description in the modularized liquid crystal display device 20 of the first preferred embodiment, so for the specific details refer to the related description in the modularized liquid crystal display device 20 of the first preferred embodiment.

Based on the first preferred embodiment, by disposing the heat sink projection component, the modularized liquid crystal display device of the preferred embodiment can further increase the luminous efficiency, so as to further reduce the whole of the volume of the modularized liquid crystal display device.

In the modularized liquid crystal display device according to the preferred embodiment of the present invention, by the design of the structure of the containing space, the structure of the modularized liquid crystal display device is simplified, and the heat dissipation effect of the modularized liquid crystal display device is increased. Furthermore, since the luminous efficiency is increased, the energy consumption of the modularized liquid crystal display device is lowered. Therefore, it can solve the technical problems of the prior art: a conventional modularized liquid crystal display device has a larger integral volume, and the energy consumption and the heat dissipation effect are worse.

The present invention has been described with preferred embodiments thereof and it is understood that many changes and modifications to the described embodiment can be carried out without departing from the scope and the spirit of the invention that is intended to be limited only by the appended claims.

What is claimed is:

1. A modularized liquid crystal display device, comprising:
a first liquid crystal display panel;
a second liquid crystal display panel;
a light source module disposed on upper portions of the first liquid crystal display panel and the second liquid crystal display panel; and
two sided sealing structural components disposed on side portions of the first liquid crystal display panel and the second liquid crystal display panel;
wherein lower portions of the first liquid crystal display panel and the second liquid crystal display panel are connected to each other; and a sealed containing space is constructed by the first liquid crystal display panel, the second liquid crystal display panel, the light source module, and the two sided sealing structural components;
wherein the light source module includes: LED light sources disposed inside the containing space; at least one reflection sheet configured to reflect lights emitted from the LED light sources; and a heat sink disposed outside the containing space;
wherein an included angle between a plane of the first liquid crystal display panel and a plane of the second liquid crystal display panel is less than or equal to 120 degrees; and
wherein a surface of the first liquid crystal display panel facing the containing space is provided with a first optical film set; and a surface of the second liquid crystal display panel facing the containing space is provided with a second optical film set.

2. The modularized liquid crystal display device according to claim 1, wherein the LED light sources are disposed inside the containing space by a light source layout plate; and the reflection sheet is disposed among the adjacent LED light sources.

3. The modularized liquid crystal display device according to claim 2, wherein on the light source layout plate, an area with a smaller arranging-distance-value has a greater distribution density of the LED light sources than that of an area with a greater arranging-distance-value, wherein the arranging-distance-value is an absolute value of an difference value between a distance from the area to the first liquid crystal display panel, and a distance from the area to the second liquid crystal display panel.

4. The modularized liquid crystal display device according to claim 1, wherein the LED light sources are disposed inside the sealed containing space by a projection component, and two of the reflection sheets are disposed on two sides of the projection component.

5. The modularized liquid crystal display device according to claim 4, wherein the LED light sources are evenly disposed on outer surfaces of the projection component.

6. The modularized liquid crystal display device according to claim 1, wherein the LED light sources are disposed inside the sealed containing space by a heat sink projection component, and two of the reflection sheets are disposed on two sides of the projection component.

7. The modularized liquid crystal display device according to claim 6, wherein the heat sink projection component is connected with the heat sink.

8. The modularized liquid crystal display device according to claim 1, wherein a surface of the sided sealing structural components facing the containing space is provided with the reflection sheet.

9. A modularized liquid crystal display device, comprising:
a first liquid crystal display panel;
a second liquid crystal display panel;
a light source module disposed on upper portions of the first liquid crystal display panel and the second liquid crystal display panel; and
two sided sealing structural components disposed on side portions of the first liquid crystal display panel and the second liquid crystal display panel;
wherein lower portions of the first liquid crystal display panel and the second liquid crystal display panel are connected to each other; and a sealed containing space is constructed by the first liquid crystal display panel, the second liquid crystal display panel, the light source module, and the two sided sealing structural components;
wherein the light source module includes: LED light sources disposed inside the containing space; at least one reflection sheet configured to reflect lights emitted from the LED light sources; and a heat sink disposed outside the containing space.

10. The modularized liquid crystal display device according to claim 9, wherein the LED light sources are disposed inside the containing space by a light source layout plate; and the reflection sheet is disposed among the adjacent LED light sources.

11. The modularized liquid crystal display device according to claim 10, wherein on the light source layout plate, an area with a smaller arranging-distance-value has a greater distribution density of the LED light sources than that of an area with a greater arranging-distance-value, wherein the arranging-distance-value is an absolute value of an difference value between a distance from the area to the first liquid crystal display panel, and a distance from the area to the second liquid crystal display panel.

12. The modularized liquid crystal display device according to claim 9, wherein the LED light sources are disposed inside the sealed containing space by a projection component, and two of the reflection sheets are disposed on two sides of the projection component.

13. The modularized liquid crystal display device according to claim 12, wherein the LED light sources are evenly disposed on outer surfaces of the projection component.

14. The modularized liquid crystal display device according to claim 9, wherein the LED light sources are disposed inside the sealed containing space by a heat sink projection component, and two of the reflection sheets are disposed on two sides of the projection component.

15. The modularized liquid crystal display device according to claim 14, wherein the heat sink projection component is connected with the heat sink.

16. The modularized liquid crystal display device according to claim 9, wherein an included angle between a plane of the first liquid crystal display panel and a plane of the second liquid crystal display panel is less than or equal to 120 degrees.

17. The modularized liquid crystal display device according to claim 9, wherein a surface of the first liquid crystal display panel facing the containing space is provided with a first optical film set; and a surface of the second liquid crystal display panel facing the containing space is provided with a second optical film set.

18. The modularized liquid crystal display device according to claim 9, wherein a surface of the sided sealing structural components facing the containing space is provided with the reflection sheet.
